(19) United States
(12) Patent Application Publication
(10) Pub. No.: US 2024/0066832 A1
(43) Pub. Date: Feb. 29, 2024

(54) Woven Material

(71) Applicant: Ruggable LLC, Gardena, CA (US)

(72) Inventors: Pauline Victoria Sheets, Long Beach, CA (US); Therese Mona-Lisa Germain, Los Angeles, CA (US); Jordan David Marzouk, Santa Monica, CA (US)

(73) Assignee: Ruggable LLC, Gardena, CA (US)

(21) Appl. No.: 17/823,601

(22) Filed: Aug. 31, 2022

(51) Int. Cl. B32B 5/02; D03D 1/00; D03D 15/283

(52) U.S. Cl. CPC B32B 5/024; D03D 1/0017; D03D 15/283; B32B 2262/0276; B32B 2307/7265; B32B 2307/744; B32B 2471/00; D10B 2331/04; D10B 2503/04

(57) ABSTRACT

Disclosed is a woven material, comprising alternating regions of plain weave and twill weave. A thick yarn, such as chenille yarn, is woven through a plain weave base in a twill weave pattern The woven material is able to maintain dimensional stability even after undergoing multiple wash and dry cycles, and is appropriate for use in a variety of applications, such as to be made into rugs.

### TECHNICAL FIELD

This disclosure relates to a woven material that may be used for various applications, including incorporation into household goods such as rugs and other floor coverings.

### BACKGROUND ART

Weaving is a process by which yarns or threads are interlaced at right angles to make a fabric. A woven material is commonly made on a loom, which holds “warp” threads in a vertical or longitudinal direction while interlacing horizontal or latitudinal “weft” threads through the warp threads. Woven material is used in a wide range of products, including household products such as rug and floor mats.

FIG. 1 shows a top-down view of a basic example of a prior art plain weave. In a fabric 100, a plurality of warp threads and a plurality of weft threads are interlaced to form a simple crisscross pattern 101. For instance, a first weft thread 121 goes over a first warp thread 111, under a second warp thread 112, and over a third warp thread 113 and so on in an alternating pattern. A second weft thread 122, which is situated adjacent to and below the first weft thread 121, in turn goes under the first warp thread 111, over the second warp thread 112, under the third warp thread 113, and so on in an alternating pattern. This alternating pattern repeats across the plain weave. Although FIG. 1 shows a basic 1×1 plain weave, variations on the plain weave are known in the art.

FIG. 2 shows a top-down view of a basic example of a prior art twill weave. In a fabric 200, a plurality of warp threads and a plurality of weft threads are interlaced to form a pattern of diagonal parallel ribs 201. For instance, a first weft thread 221 goes under a first warp thread 211 and a second warp thread 212, then over a third warp thread 213 and a fourth warp thread 214, and so on in an alternating pattern. A second weft thread 222 in turn goes over the first warp thread 211, under the second warp thread 212 and third warp thread 213, over the fourth warp thread 214 and a fifth warp thread 215, and so on in an alternating pattern. This alternating pattern repeats across the twill weave. Although FIG. 2 shows a basic twill weave, variations on the twill weave are known in the art.

### SUMMARY

Existing woven materials may exhibit some characteristics considered undesirable when incorporated into household goods such as rugs, especially when they have gone through multiple wash and dry cycles. Many consider it important to be able to easily wash rugs in order to maintain a clean and sanitary living environment.

FIG. 3 shows an example of a prior art rug 300 that is characteristic of some but not all existing rug products. This rug 300 exhibits poor material stability, which is manifested as wrinkles 301 on its top surface. The wrinkles 301 may catch a person's foot as she walks across the rug 300, and thus presents a safety hazard. The wrinkles 301 may also be considered by some to be aesthetically undesirable.

FIGS. 4 and 5 show examples of prior art rugs 400 and 500 that are characteristic of some but not all existing rug products. Rug 400 exhibits curling 401 at its corners, while Rug 500 exhibits curling 501 at its corners. The curling on these rugs may present tripping hazards and may also be considered aesthetically unappealing.

The problems shown in the examples depicted in FIGS. 3-5 may be exacerbated by washing and drying of the rugs. Many existing rugs use woven material as one of its component layers, including as the top layer, but the woven material often deform over time, especially upon repeated exposure to water and heat, such as through multiple wash and dry cycles. The deformation may stem in part from the tendency of the yarns and threads making up the woven material to shrink in these conditions. This deformation can be exacerbated where different yarns and threads that shrink and curl at different rates are used for the warp and weft. Yet, it oftentimes may be desirable to use different yarns and threads to make up a woven material, such as for aesthetic or comfort reasons.

Accordingly, there is a need for a woven material that improves on downsides exhibited by some existing products.

Disclosed is a woven material that may be used for various applications, particularly for use in rugs and other floor coverings. The woven material may be used as one component layer of a larger stack of materials. The woven material may be used in a one-piece or two-piece rug system.

### BRIEF DESCRIPTION OF THE DRAWINGS

FIG. 1 is a top-down view of an example of a prior art fabric made of a plain weave.

FIG. 2 is a top-down view of an example of a prior art fabric made of a twill weave.

FIG. 3 shows an example of a prior art rug that exhibits wrinkles.

FIG. 4 shows an example of a prior art rug that exhibits curling at its corners.

FIG. 5 shows an example of a prior art rug that exhibits curling at its edges.

FIG. 6 is a top-down view of woven material according to an embodiment.

FIG. 7 is a side view of an example of a composite material comprising the woven material as a top layer.

### DETAILED DESCRIPTION

Disclosed is a woven material. The material can be used in household applications, such as to make rugs, but also can be used for other applications.

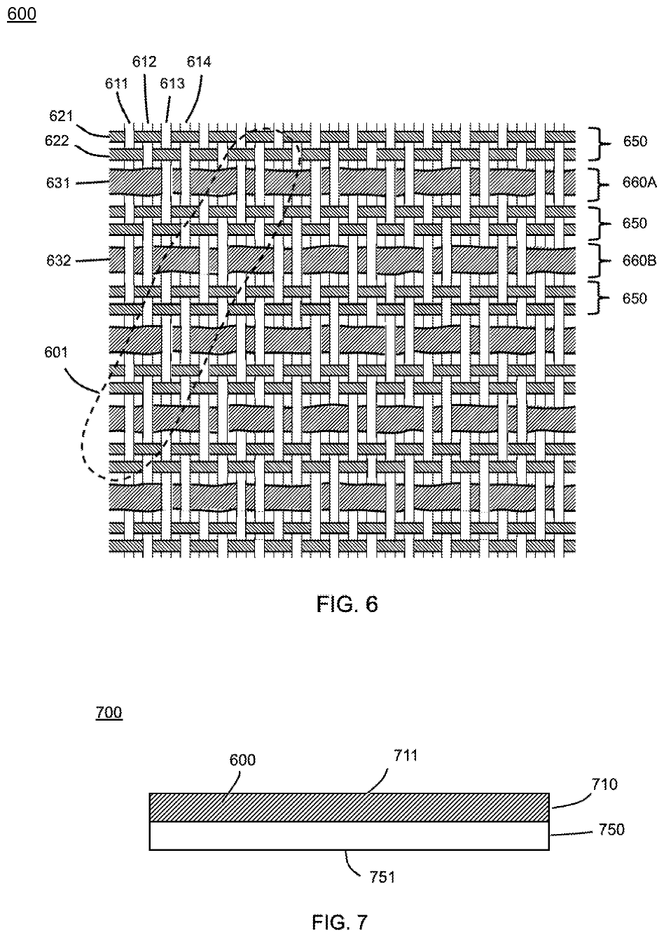

Reference is made to FIG. 6, which is not to scale but drawn to clearly show the features of the embodiment. A fabric 600 comprises a plurality of warp threads, a plurality of thin weft threads, and a plurality of thick weft yarns. These threads and yarns are interlaced to form a composite weave that combines a plurality of alternating plain weave regions 650 and twill weave regions 660. In an embodiment, the warp threads and thin weft threads are basic but strong polyester threads while the thick weft yarns are a more decorative and plusher type of polyester chenille yarn. However, an artisan would recognize that different combinations of threads and/or yarns may be used.

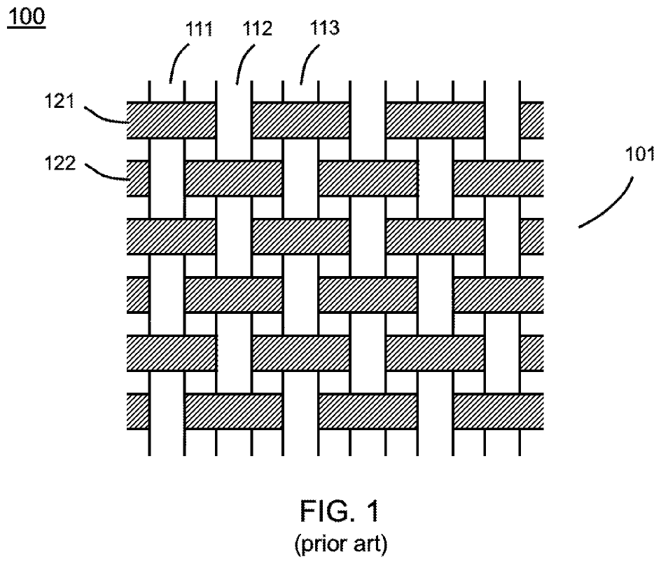

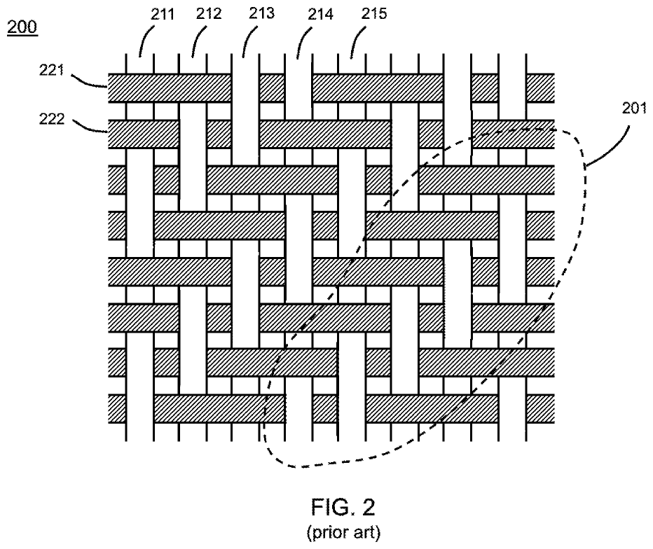

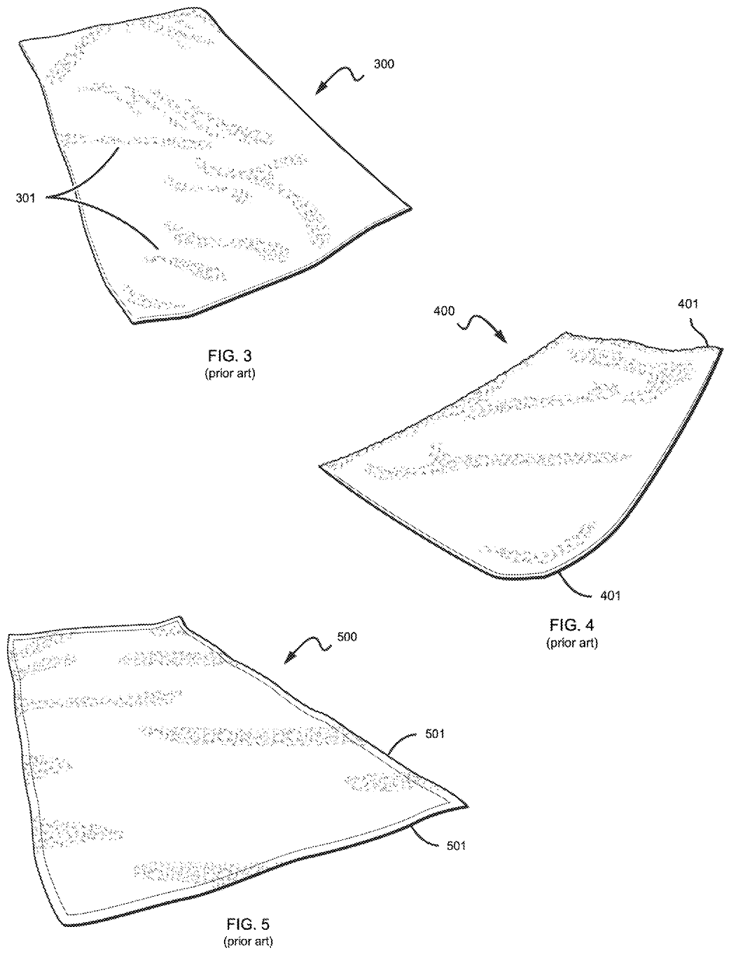

As shown in FIG. 6, a plain weave region 650 comprises a plurality of warp threads and a plurality of thin weft threads. These threads are interlaced in a way similar to that shown in FIG. 1, wherein a thin weft thread 621 goes under a warp thread 611, then over the next warp thread 612, and so on, while a thin weft thread 622, situated directly below thin weft thread 611, goes over warp thread 611, under warp thread 612, and so on. Although the use of a basic 1×1 plain weave is disclosed herein, artisans will recognize that variations on the plain weave may be used instead.

A twill weave region 660A, situated between two plain weave regions 650, comprises a plurality of warp threads and a thick weft yarn, where the thick weft yarn goes under and over two warp threads at a time. For instance, a thick weft yarn 631 goes over warp thread 611 and warp thread 612, then under warp thread 613 and warp thread 614, and so on. In twill weave region 660B, which is situated below twill weave region 660A, with a plain weave region 650 in between them, a thick weft yarn 632 goes under warp thread 611 and warp thread 612, then over warp thread 613 and warp thread 614, and so on. Although the use of a basic twill weave is disclosed herein, in artisans will recognize that variations on the twill weave may be used instead.

As discussed above, the fabric 600 of the exemplary embodiment of FIG. 6 uses one type of warp thread (e.g., 611, 612) and two types of weft material: a thin weft thread (e.g., 621, 622) and a thick weft yarn (e.g., 631, 632). One way to conceptualize the fabric 600 is that it comprises a plain weave base made of the warp thread and thin weft thread, and thick weft yarn is woven through the base by a twill weave. In an embodiment, the thick weft yarn may be a spun chenille yarn made of polyester fibers. In the weave structure disclosed here, much of the chenille yarn is exposed on the top surface of the fabric 600, essentially sitting on top of the plain weave base. One benefit of this structure is that it creates a plush surface for the fabric 600, leading to a comfortable feel that may be desirable in household goods such as rugs and other floor coverings. Another benefit of this structure is that it makes the fabric 600 more amenable to surface treatment, such as color application. The thickness and absorbency of the chenille yarns allow for good uptake of liquid-based surface treatments.

In a preferred embodiment, the warp thread (e.g., 611, 612) may be a polyester thread and its weight may be in the range of about 125 denier to about 175 denier, such as about 150 denier. The thin weft thread (e.g., 621, 622) may also be a polyester thread and its weight may be in the range of about 250 denier to about 350 denier, such as about 300 denier. The thick weft yarn (e.g., 631, 632) may be a chenille yarn of about 2.5 staple; that is, it is spun from fibers of about 2.5 inches long. In the alternative, yarn of different staple can be used, such as yarn having staple in the range of about 2.0 to about 3.0 staple.

The woven material as disclosed herein has been found to have some resistance to wrinkling, curling, and peeling, particularly through multiple wash and dry cycles. In particular, the thin weft thread (e.g., 621, 622) and thick weft yarn (e.g., 631, 632) are optimized both by the weave structure and the material specifications to shrink at approximately the same rate when undergoing the application of water and heat. This helps the entire fabric 600 to shrink at about a consistent rate, reducing the incidence of dimensional instability.

FIG. 7 is a side view of an example of a composite material stack 700 that makes use of the fabric 600 as a component. In an embodiment, the stack 700 may be a rug or floor mat. As shown, the composite material comprises a top layer 710 and a bottom layer 750. The top layer 710 comprises fabric 600 such that the top surface 711 of the stack 700 is provided by the fabric 600. Where chenille yarns as described above are used in the fabric 600, the top 711 provides a lustrous look and comfortable feel. The bottom layer 750 may comprise one or more layers of material, including, for example: (1) a layer of thermoplastic polyurethane or like material to prevent water penetration and/or further improve material stability, (2) a layer of cushioning material, such as spacer fabric, V-Lap, or foam, to improve comfort, (3) a base layer that provides a bottom-facing surface 751 of non-slip material or other material designed to attach to a separate rug pad. The top layer 710 and bottom layer 750, as well as any constituent layers of the bottom layer 750, may be attached to each other by the use of adhesives such as hot melt adhesive.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including, “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure and the principles and the novel features disclosed herein.

1. A woven material, comprising:
a plurality of warp threads;
a plurality of weft threads; and
a plurality of weft yarns;
wherein a subset of the plurality of warp threads and a subset of the plurality of weft threads are woven together in a plain weave; and
a subset of the plurality of warp threads and a subset of the plurality of weft yarns are woven together in a twill weave.

2. The woven material of claim 1, wherein the plurality of warp threads, the plurality of weft threads, and the plurality of warp yarns are made of polyester.

3. The woven material of claim 2, wherein the plurality of warp threads has a weight within a range of about 125 denier to about 175 denier.

4. The woven material of claim 2, wherein the plurality of warp threads has a weight of about 150 denier.

5. The woven material of claim 2, wherein the plurality of warp threads has a weight within a range of about 250 denier to about 350 denier.

6. The woven material of claim 2, wherein the plurality of warp threads has a weight of about 200 denier.

7. The woven material of claim 2, wherein the plurality of warp yarns has a staple within a range of about 2.0 to 3.0 staple.

8. The woven material of claim 2, wherein the plurality of warp yarns has a staple of about 2.5 staple.

9. A rug comprising:
A first layer of a woven material comprising a plurality of warp threads, a plurality of weft threads, and a plurality of weft yarns;
wherein a subset of the plurality of warp threads and a subset of the plurality of weft threads are woven together in a plain weave; and
a subset of the plurality of warp threads and a subset of the plurality of weft yarns are woven together in a twill weave; and
a second layer situated under and attached to the first layer.

10. The rug of claim 9, wherein the plurality of warp threads, the plurality of weft threads, and the plurality of warp yarns are made of polyester.

11. The rug of claim 10, wherein the plurality of warp threads has a weight within a range of about 125 denier to about 175 denier.

12. The rug of claim 10, wherein the plurality of warp threads has a weight of about 150 denier.

13. The rug of claim 10, wherein the plurality of warp threads has a weight within a range of about 250 denier to about 350 denier.

14. The rug of claim 10, wherein the plurality of warp threads has a weight of about 200 denier.

15. The rug of claim 10, wherein the plurality of warp yarns has a staple within a range of about 2.0 to 3.0 staple.

16. The rug of claim 10, wherein the plurality of warp yarns has a staple of about 2.5 staple.

17. The rug of claim 10, wherein the second layer comprises a liquid barrier layer.

18. The rug of claim 10, wherein the second layer comprises a cushioning layer.

19. The rug of claim 10, wherein the second layer comprises a non-slip layer.

20. The rug of claim 10, wherein the second layer comprises a material configured to removably attach to a separate rug pad.
